(19) United States
(12) Patent Application Publication
(10) Pub. No.: US 2026/0368625 A1
(43) Pub. Date: Nov. 19, 2026

(54) PROVIDING ENCRYPTED MACHINE LEARNING MODEL TRAINING AND RESULT GENERATION

(71) Applicant: International Business Machines Corporation, Armonk, NY (US)

(72) Inventors: Hirenkumar Ashokbhai THUMMAR, Santa Clara, CA (US); Linda Ha KATO, San Jose, CA (US); Chad Eric DeLUCA, Morgan HIll, CA (US); Daniel GRUHL, San Jose, CA (US); Shubhi ASTHANA, San Jose, CA (US); Pawan Raghunath CHOWDHARY, San Jose, CA (US); Steven R. WELCH, Gilroy, CA (US); Anna Lisa GENTILE, San Jose, CA (US); Bing ZHANG, San Jose, CA (US); Alfredo ALBA, Morgan Hill, CA (US)

(21) Appl. No.: 19/209,895

(22) Filed: May 16, 2025

(51) Int. Cl. G06N 20/00; H04L 9/08; H04L 9/14

(52) U.S. Cl. CPC G06N 20/00; H04L 9/0825; H04L 9/14

(57) ABSTRACT

In some implementations, a computer system may receive training data, and may encrypt the training data to generate encrypted training data. The computer system may train a machine learning model with the encrypted training data to generate a trained machine learning model, and may receive a query from a user device associated with a user. The computer system may encrypt the query to generate an encrypted query, and may process the encrypted query, with the trained machine learning model, to generate an encrypted result. The computer system may provide the encrypted result to the user device.

### BACKGROUND

The field of artificial intelligence (AI) generally involves the use of machine learning models to analyze and process data. These machine learning models are often used in various applications to process and utilize different types of data.

### SUMMARY

Some aspects described herein relate to a method. The method may include receiving training data, and encrypting the training data to generate encrypted training data. The method may include training a machine learning model with the encrypted training data to generate a trained machine learning model, and receiving a query from a user device associated with a user. The method may include encrypting the query to generate an encrypted query, and processing the encrypted query, with the trained machine learning model, to generate an encrypted result. The method may include providing the encrypted result to the user device.

Some aspects described herein relate to a computer system. The computer system may include a processor set, one or more computer-readable storage media, and program instructions stored on the one or more computer-readable storage media to cause the processor set to perform operations. The operations may include receiving training data, and encrypting the training data to generate encrypted training data. The operations may include training a machine learning model with the encrypted training data to generate a trained machine learning model, and receiving a query from a user device associated with a user. The operations may include encrypting the query to generate an encrypted query, and processing the encrypted query, with the trained machine learning model, to generate an encrypted result. The operations may include providing the encrypted result to the user device, wherein the encrypted result causes the user device to utilize one or more private keys to decrypt the encrypted result and generate a result and to provide the result for display to the user.

Some aspects described herein relate to a computer program product. The computer program product may include one or more computer-readable storage media and program instructions stored on the one or more computer-readable storage media to perform operations. The operations may include receiving training data, and encrypting the training data using a format-preserving encryption technique to generate encrypted training data. The operations may include training a machine learning model with the encrypted training data to generate a trained machine learning model, and receiving a query from a user device associated with a user. The operations may include encrypting the query using the format-preserving encryption technique to generate an encrypted query, and processing the encrypted query, with the trained machine learning model, to generate an encrypted result. The operations may include providing the encrypted result to the user device.

### BRIEF DESCRIPTION OF THE DRAWINGS

FIG. 1 is a diagram of an example computing environment for providing encrypted machine learning model training and result generation, as described herein.

FIGS. 2A-2G are diagrams of an example associated with providing encrypted machine learning model training and result generation.

FIG. 3 is a flowchart of an example process associated with providing encrypted machine learning model training and result generation.

### DETAILED DESCRIPTION

The following detailed description of example implementations refers to the accompanying drawings. The same reference numbers in different drawings may identify the same or similar elements.

Cloud-based machine learning models require access to large amounts of data, which can be sensitive in nature. This data may include personally identifiable information (PII), corporate secrets, or documents with security classifications. However, current methods of training a machine learning model require decrypting training data before training the machine learning model, which can expose sensitive information to unauthorized parties. This is particularly problematic in cloud-based environments where the training data may be processed and stored on third-party servers. Furthermore, once the machine learning model is trained on sensitive data, the machine learning model may contain decrypted text, which can be vulnerable to exploitation. Searching for specific information within encrypted training data without decrypting the training data first is also a significant technical challenge. Thus, current methods for training and utilizing machine learning models consume computing resources (e.g., processing resources, memory resources, communication resources, and/or the like), networking resources, and/or the like associated with attempting to decrypt training data prior to training machine learning models, handling exposure of sensitive information to unauthorized parties during training of machine learning models, handling exposure of sensitive information to unauthorized parties during utilization of machine learning models, and/or the like.

Some implementations described herein provide a computer system for providing encrypted machine learning model training and result generation. For example, the computer system may receive training data, and may encrypt the training data to generate encrypted training data. The computer system may train a machine learning model with the encrypted training data to generate a trained machine learning model, and may receive a query from a user device associated with a user. The computer system may encrypt the query to generate an encrypted query, and may process the encrypted query, with the trained machine learning model, to generate an encrypted result. The computer system may provide the encrypted result to the user device. If the user is authorized, the user device may decrypt the encrypted result to generate a result, and may present the result to the user. If the user is unauthorized, the user device may fail to decrypt the encrypted result and may present an error message to the user.

In this way, the computer system provides encrypted machine learning model training and result generation. For example, the computer system may reduce the computational overhead associated with protecting sensitive data by avoiding the need to implement additional data anonymization or pseudonymization techniques. The computer system may minimize the risk of data breaches and associated resource-intensive incident response efforts. Additionally, the computer system may enable efficient encryption and decryption of data without requiring significant additional computational resources or bandwidth. Furthermore, the computer system may reduce storage requirements by enabling secure data storage without requiring redundant or duplicate storage of sensitive data. Thus, the computer system conserves computing resources, networking resources, and/or the like that would otherwise have been consumed by attempting to decrypt training data prior to training machine learning models, handling exposure of sensitive information to unauthorized parties during training of machine learning models, handling exposure of sensitive information to unauthorized parties during utilization of machine learning models, and/or the like.

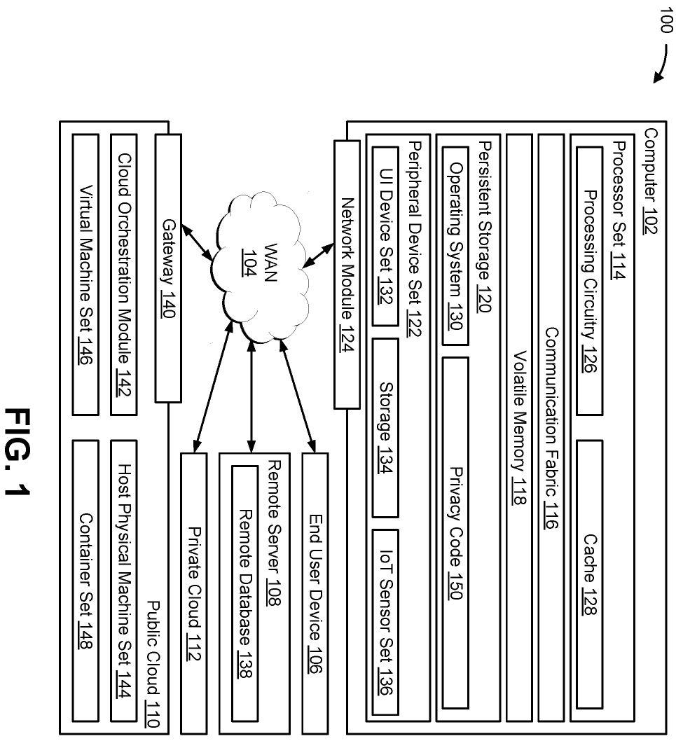

FIG. 1 is a diagram of an example computing environment 100 for providing encrypted machine learning model training and result generation, as described herein.

Computing environment 100 contains an example of an environment for the execution of at least some of the computer code involved in performing the inventive methods, such as privacy code 150. In addition to privacy code 150, computing environment 100 includes, for example, a computer 102, a wide area network (WAN) 104, an end user device (EUD) 106, a remote server 108, a public cloud 110, and a private cloud 112. In this embodiment, computer 102 includes a processor set 114 (including processing circuitry 126 and a cache 128), a communication fabric 116, a volatile memory 118, persistent storage 120 (including an operating system 130 and privacy code 150, as identified above), a peripheral device set 122 (including a user interface (UI) device set 132, storage 134, and an Internet of Things (IoT) sensor set 136), and a network module 124. Remote server 108 includes a remote database 138. Public cloud 110 includes a gateway 140, a cloud orchestration module 142, a host physical machine set 144, a virtual machine set 146, and a container set 148.

Computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 138. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

Processor set 114 includes one, or more, computer processors of any type now known or to be developed in the future. Processing circuitry 126 may be distributed over multiple packages (for example, multiple, coordinated integrated circuit chips). Processing circuitry 126 may implement multiple processor threads and/or multiple processor cores. Cache 128 is memory that is located in the processor chip package(s) and is typically used for data or code that should be available for rapid access by the threads or cores running on processor set 114. Cache memories are typically organized into multiple levels depending upon relative proximity to the processing circuitry. Alternatively, some, or all, of the cache for the processor set may be located “off chip.” In some computing environments, processor set 114 may be designed for working with qubits and performing quantum computing.

Computer-readable program instructions are typically loaded onto computer 102 to cause a series of operational steps to be performed by processor set 114 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 128 and the other storage media discussed below. The program instructions, and associated data, are accessed by processor set 114 to control and direct performance of the inventive methods. In computing environment 100, at least some of the instructions for performing the inventive methods may be stored in privacy code 150 in persistent storage 120.

Communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 118 is any type of volatile memory now known or to be developed in the future. Examples include dynamic type random access memory (RAM) or static type RAM. Typically, volatile memory 118 is characterized by random access, but this is not required unless affirmatively indicated. In computer 102, the volatile memory 118 is located in a single package and is internal to computer 102, but, alternatively or additionally, the volatile memory may be distributed over multiple packages and/or located externally with respect to computer 102.

Persistent storage 120 is any form of non-volatile storage for computers that is now known or to be developed in the future. The non-volatility of this storage means that the stored data is maintained regardless of whether power is being supplied to computer 102 and/or directly to persistent storage 120. Persistent storage 120 may be a read only memory (ROM), but typically at least a portion of the persistent storage allows writing of data, deletion of data, and re-writing of data. Some familiar forms of persistent storage include magnetic disks and solid-state storage devices. Operating system 130 may take any of several forms, such as various known proprietary operating systems or open source Portable Operating System Interface-type operating systems that employ a kernel.

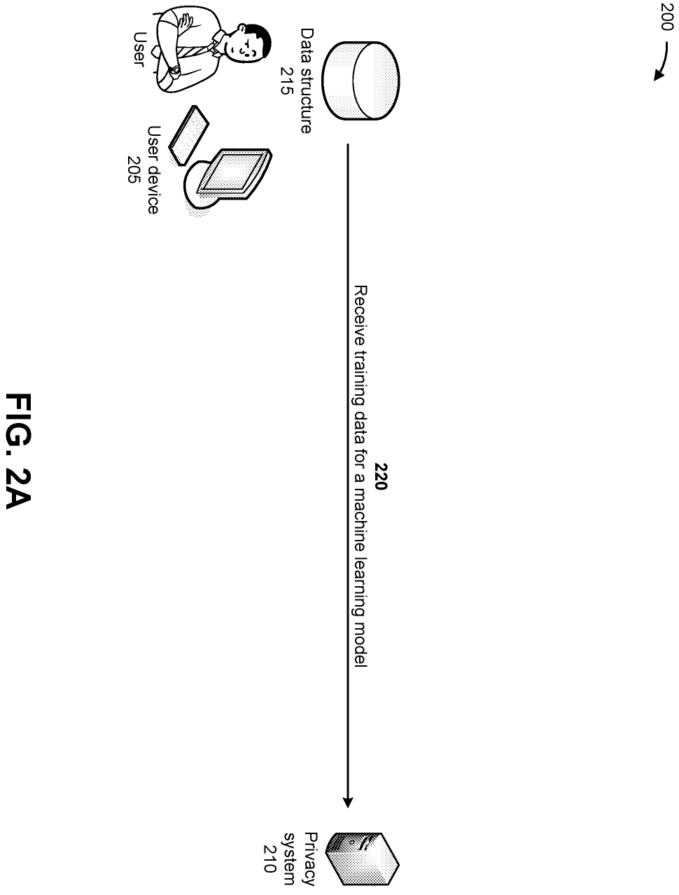

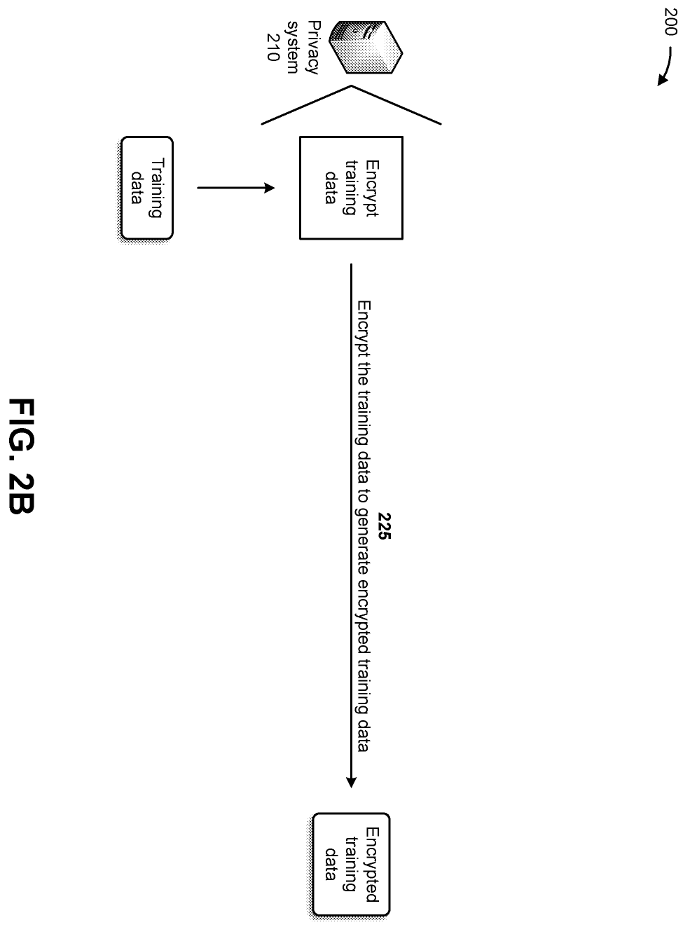

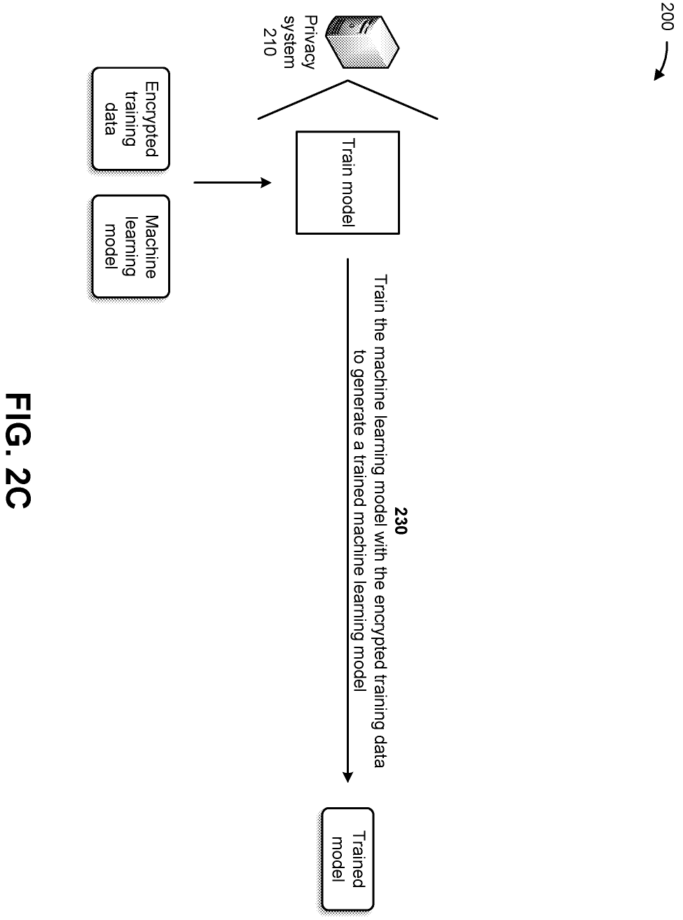

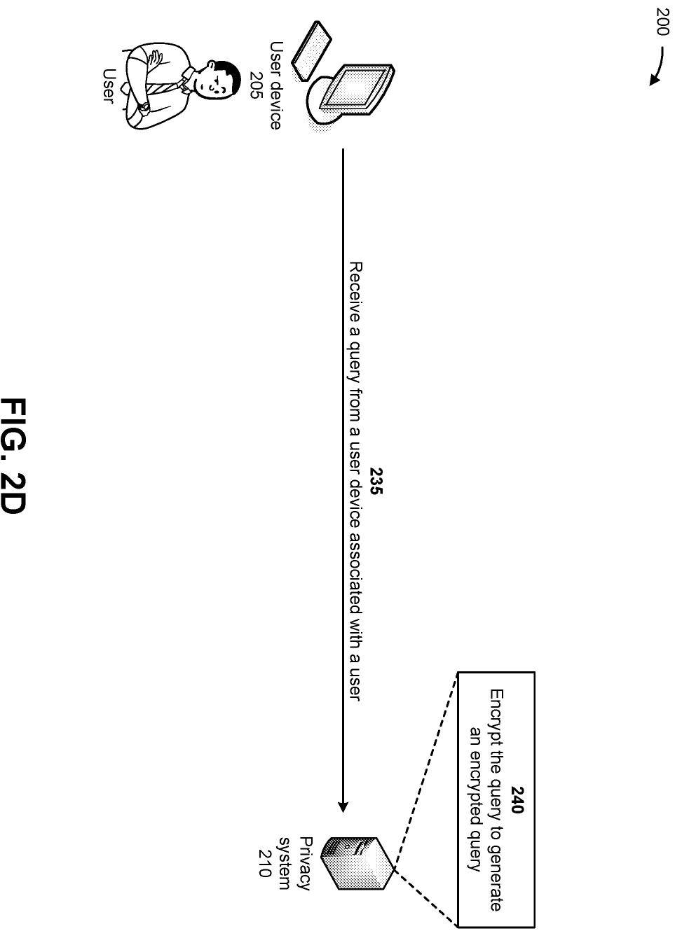

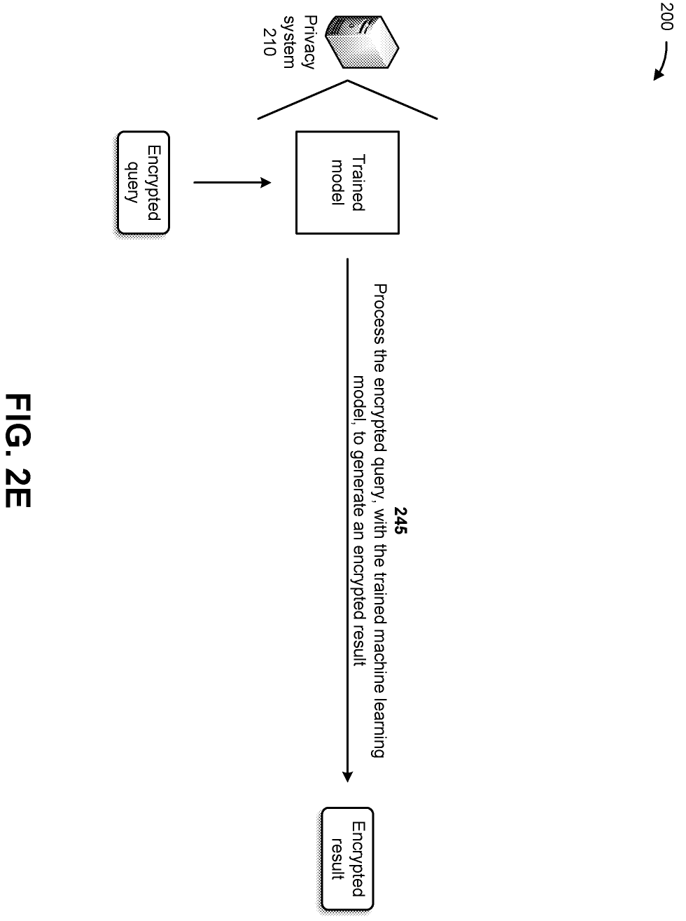

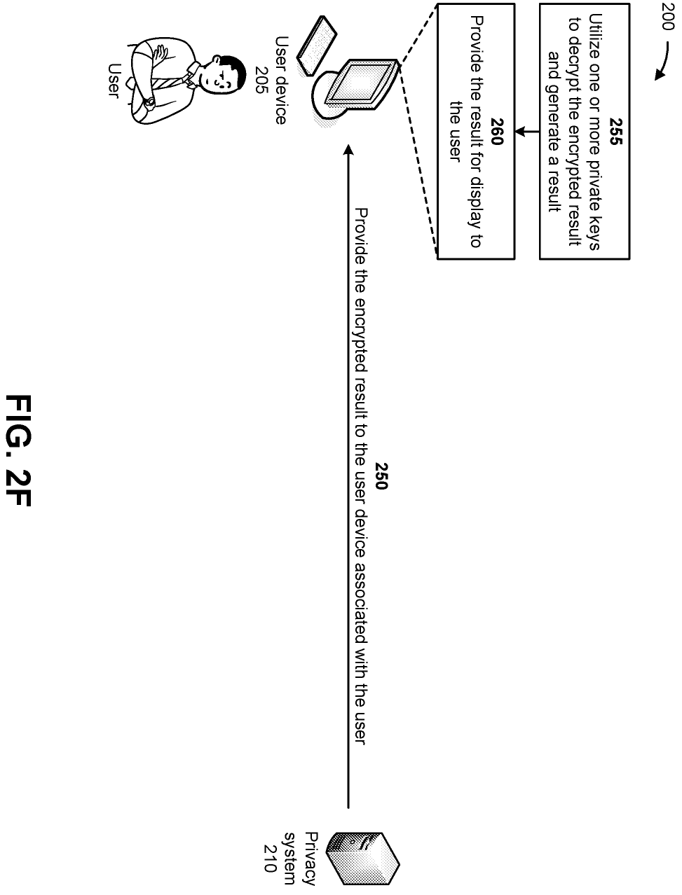

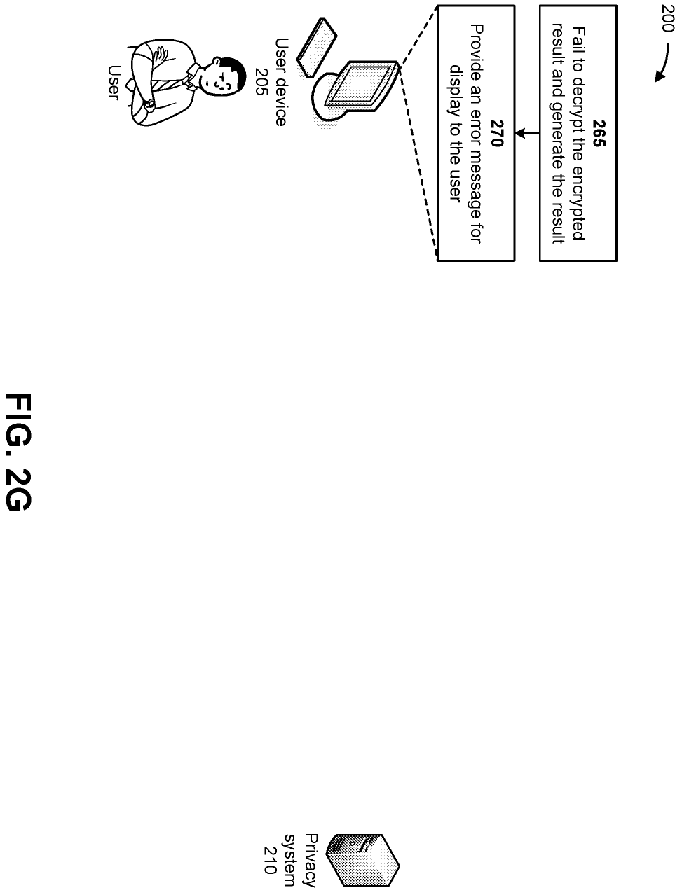

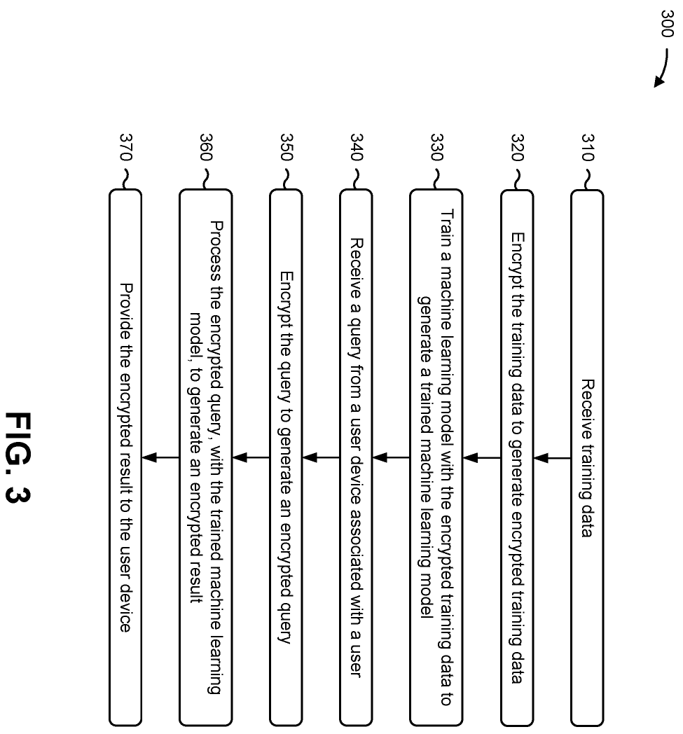

The code included in the privacy code 150 typically includes at least some of the computer code involved in performing one or more operations described herein, such as the operations of implementation 200 in FIGS. 2A-2G and the process described in FIG. 3.

Peripheral device set 122 includes the set of peripheral devices of computer 102. Data communication connections between the peripheral devices and the other components of computer 102 may be implemented in various ways, such as Bluetooth® connections, Near-Field Communication (NFC) connections, connections made by cables (such as universal serial bus (USB) type cables), insertion-type connections (for example, secure digital (SD) card), connections made through local area communication networks and/or connections made through wide area networks such as the internet. In various embodiments, UI device set 132 may include components such as a display screen, speaker, microphone, wearable devices (such as goggles and smart watches), keyboard, mouse, printer, touchpad, game controllers, and/or haptic devices. Storage 134 is external storage, such as an external hard drive, or insertable storage, such as an SD card. Storage 134 may be persistent and/or volatile. In some embodiments, storage 134 may take the form of a quantum computing storage device for storing data in the form of qubits. In embodiments where computer 102 is required to have a large amount of storage (for example, where computer 102 locally stores and manages a large database), this storage may be provided by peripheral storage devices designed for storing very large amounts of data, such as a storage area network (SAN) that is shared by multiple, geographically distributed computers. IoT sensor set 136 is made up of sensors that can be used in Internet of Things applications. For example, one sensor may be a thermometer and another sensor may be a motion detector.

Network module 124 is the collection of computer software, hardware, and firmware that allows computer 102 to communicate with other computers through WAN 104. Network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 124 are performed on the same physical hardware device. In other embodiments (for example, embodiments that utilize software-defined networking (SDN)), the control functions and the forwarding functions of network module 124 are performed on physically separate devices, such that the control functions manage several different network hardware devices. Computer-readable program instructions for performing the inventive methods can typically be downloaded to computer 102 from an external computer or external storage device through a network adapter card or network interface included in network module 124.

WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and/or edge servers.

EUD 106 is any computer system that is used and controlled by an end user (for example, a customer of an enterprise that operates computer 102), and may take any of the forms discussed above in connection with computer 102. EUD 106 typically receives helpful and useful data from the operations of computer 102. For example, in a hypothetical case where computer 102 is designed to provide a recommendation to an end user, this recommendation would typically be communicated from network module 124 of computer 102 through WAN 104 to EUD 106. In this way, EUD 106 can display, or otherwise present, the recommendation to an end user. In some embodiments, EUD 106 may be a client device, such as thin client, heavy client, mainframe computer, desktop computer and so on.

Remote server 108 is any computer system that serves at least some data and/or functionality to computer 102. Remote server 108 may be controlled and used by the same entity that operates computer 102. Remote server 108 represents the machine(s) that collect and store helpful and useful data for use by other computers, such as computer 102. For example, in a hypothetical case where computer 102 is designed and programmed to provide a recommendation based on historical data, this historical data may be provided to computer 102 from remote database 138 of remote server 108.

Public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 110 is performed by the computer hardware and/or software of cloud orchestration module 142. The computing resources provided by public cloud 110 are typically implemented by virtual computing environments that run on various computers making up the computers of host physical machine set 144, which is the universe of physical computers in and/or available to public cloud 110. The virtual computing environments (VCEs) typically take the form of virtual machines from virtual machine set 146 and/or containers from container set 148. These VCEs may be stored as images and may be transferred among and between the various physical machine hosts, either as images or after instantiation of the VCE. Cloud orchestration module 142 manages the transfer and storage of images, deploys new instantiations of VCEs, and manages active instantiations of VCE deployments. Gateway 140 is the collection of computer software, hardware, and firmware that allows public cloud 110 to communicate through WAN 104.

Some further explanation of VCEs will now be provided. VCEs can be stored as “images.” A new active instance of a VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 112 is similar to public cloud 110, except that the computing resources are only available for use by a single enterprise. While private cloud 112 is depicted as being in communication with WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this example, public cloud 110 and private cloud 112 are both part of a larger hybrid cloud.

Cloud computing services and/or microservices (not separately shown in FIG. 1): private and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to an “as a service” technology paradigm where content is being presented to an internal or external customer in the form of a cloud computing service. As-a-service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with such tasks. Another category is Software-as-a-Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the computing environment 100 may perform one or more functions described as being performed by another set of devices of the computing environment 100.

FIGS. 2A-2G are diagrams of an example 200 associated with providing encrypted machine learning model training and result generation. As shown in FIGS. 2A-2G, the example 200 includes a user device 205 associated with a user, a privacy system 210, and a data structure 215. The user device 205 may correspond to the computer 102 and/or the end user device 106. The privacy system 210 may correspond to the computer 102, the end user device 106, the remote server 108, a system provided by the public cloud 110, and/or a system provided by the private cloud 112. The data structure 215 may correspond to the persistent storage 120, the remote database 138, a database, a table, and/or a list. Further details of the user device 205, the privacy system 210, and the data structure 215 are provided elsewhere herein.

As shown in FIG. 2A, and by reference number 220, the privacy system 210 may receive training data for a machine learning model. For example, the privacy system 210 may be associated with a machine learning model to be trained and utilized by the privacy system 210 in a secure manner. In some implementations, the machine learning model may include a bag-of-words model. A bag-of-words model is a type of machine learning model that represents text data as a collection of words, and that disregards an order and a context of the words. Alternatively, or additionally, the machine learning model may include a term frequency-inverse document frequency (TF-IDF) model. The TF-IDF model is an extension of the bag-of-words model that takes into account an importance of each word in an entire corpus. The TF-IDF may calculate a term frequency (TF) of each word in a document and may multiply the term frequency by an inverse document frequency (IDF), which is a measure of how rare the word is in the corpus.

Alternatively, or additionally, the machine learning model may include an N-Grams model. The N-grams model is a type of bag-of-words model that considers a context of words by grouping the words into sequences of n items. This may be useful for capturing phrases or sequences of words that have a specific meaning. Alternatively, or additionally, the machine learning model may include a latent semantic analysis (LSA) model. The LSA model may utilize singular value decomposition (SVD) to reduce a dimensionality of a bag-of-words representation. This may identify latent semantic relationships between words and improve an accuracy of text classification or clustering tasks. Alternatively, or additionally, the machine learning model may include a latent Dirichlet allocation (LDA) model. The LDA model is a type of topic model that represents documents as a mixture of topics, where each topic is a distribution over a vocabulary. This may identify underlying themes or topics in a corpus of documents. Alternatively, or additionally, the machine learning model may include a word embeddings model. A word embeddings model, such as Word2Vec or GloVe, may represent word as vectors in a high-dimensional space, where semantically similar words are mapped to nearby points. This may capture relationships between words that are not captured by the bag-of-words model or the TF-IDF model.

In some implementations, the machine learning model may include any text-based machine learning model. For example, the machine learning model may include a language model (e.g., an N-grams model, a recurrent neural networks (RNN) model or a long short-term memory (LSTM) network model), a sentiment analysis model (e.g., a naive Bayes model, a support vector machine (SVM) model, or a convolutional neural network (CNN) model), a text classification model (e.g., a decision tree model, a random forest model, or a gradient boosting machine model), a named entity recognition model (e.g., a hidden Markov model, a maximum entropy model, or a conditional random fields model), a topic model (e.g., a latent Dirichlet allocation model, a latent semantic analysis model, or a non-negative matrix factorization model).

The privacy system 210 may receive training data for a machine learning model through various methods. In some implementations, the privacy system 210 may receive the training data through a direct upload from a data source, such as the data structure 215. The data structure 215 may be located within a same organization as the privacy system 210 or may be external to the organization. Alternatively, or additionally, the privacy system 210 may receive the training data through a data streaming service, which provides a continuous flow of the training data from the data structure 215. The data streaming service may be based on a publish-subscribe model, where the data structure 215 publishes the training data to a topic and the privacy system 210 subscribes to the topic to receive the training data.

Alternatively, or additionally, the privacy system 210 may receive the training data through an API call to the data structure 215. The API call may be used to retrieve data from the data structure 215, a web service, or a cloud storage service. Alternatively, or additionally, the privacy system 210 may receive the training data through a data crawling process, which involves automatically searching and extracting data from various data sources, such as websites, social media platforms, or online forums. Alternatively, or additionally, the privacy system 210 may receive the training data through manual entry by a user. This method may be used when the data is small in size or is not available through other methods.

Once the training data is received, the privacy system 210 may perform data preprocessing to prepare the training data for training the machine learning model. This may include data cleaning (e.g., removing missing, duplicate, or erroneous data from the training data), data transformation (e.g., converting the training data from one format to another, such as converting text data to numerical data), data normalization (e.g., scaling the training data to a common range to prevent features with large ranges from dominating the machine learning model), data tokenization (e.g., splitting the training data into individual words or tokens), data encryption as described in detail below, and/or the like.

The privacy system 210 may store preprocessed training data may in a data storage system, such as a relational database, a structured query language (SQL) database, or a cloud storage service. In some implementations, the privacy system 210 may implement data access control mechanisms to ensure that only authorized users have access to the training data. This may include utilizing authentication to verify identities of users who try to access the training data, authorization to grant access to the training data only to users who have the necessary permissions, and/or encryption to encrypt the training data to prevent unauthorized access, as described below.

As shown in FIG. 2B, and by reference number 225, the privacy system 210 may encrypt the training data to generate encrypted training data. For example, the privacy system 210 may utilize a format-preserving encryption technique to encrypt the training data and generate the encrypted training data. In some implementations, the format-preserving encryption technique may include format-preserving Feistel-based encryption. The format-preserving encryption technique may preserve a format of the training data so that the encrypted training data has the same format as the training data (e.g., encrypting a string of characters to a string of characters). A Feistel network is a type of encryption algorithm that is based on the idea of dividing input data into two halves and encrypting each half separately. The encryption process is performed using a combination of substitution and permutation operations. Format-preserving encryption is a type of encryption technique that preserves the format of the input data. Thus, format-preserving Feistel-based encryption may combine the principles of format-preserving encryption and a Feistel network to create an encryption algorithm that preserves the format of the input data, while providing strong encryption.

Format-preserving Feistel-based encryption may include generating a secret key that is used for encryption and decryption, and dividing the training data is divided into two halves, each of which is treated as a separate block. A round function may be applied to each block, which involves substitution, permutation, and exclusive OR (XOR) operations. The round function may be reversible in that it can be easily inverted to retrieve the original training data. The round function may be applied to each block in a specific order, with a resulting output being the encrypted training data.

In some implementations, the privacy system 210 may encrypt the training data using other encryption techniques to generate the encrypted training data. For example, the privacy system 210 may utilize a symmetric key encryption algorithm, such as advanced encryption standard (AES), to encrypt the training data. In this approach, a same key may be utilized for both encryption and decryption. Alternatively, or additionally, the privacy system 210 may utilize an asymmetric key encryption algorithm, such as Rivest-Shamir-Adleman (RSA), to encrypt the training data. In this approach, a pair of keys may be utilized (e.g., a public key for encryption and a private key for decryption). Alternatively, or additionally, the privacy system 210 may utilize homomorphic encryption to encrypt the training data, which allows computations to be performed on the encrypted training data without decrypting the training data. In this approach, the encrypted training data may be processed using a homomorphic encryption algorithm, such as Brakerski-Gentry-Vaikuntanathan (BGV) or Fan-Vercauteren (FV). Alternatively, or additionally, the privacy system 210 may utilize tokenization to encrypt the training data. In this approach, sensitive data in the training data (e.g., credit card numbers, social security numbers, PII, and/or the like) may be replaced with a token that can be used for processing without exposing the sensitive data.

The encryption process may include the privacy system 210 generating a key or a pair of keys for encryption and decryption, and preparing the training data for encryption by converting the training data into a suitable format. The privacy system 210 may encrypt the training data using the selected encryption algorithm and key to generate the encrypted training data, and may store the encrypted training data in a secure storage system. The privacy system 210 may utilize various encryption keys to encrypt the training data, including a symmetric key (e.g., a single key that is used for both encryption and decryption), a public key (e.g., a key that is used for encryption, while a corresponding private key is used for decryption), and private key (e.g., a key that is used for decryption, while the corresponding public key is used for encryption).

In some implementations, the privacy system 210 may utilize space tokenization to scramble the characters within the training data using one or more private keys. This technique may include dividing the text into tokens (e.g., words or characters), and then encrypting each token individually while preserving the overall format and structure of the text. Space tokenization may ensure that the encrypted training data maintains the same layout and length characteristics as the original training data, which may be needed for certain types of machine learning models, such as bag-of-words models.

In some implementations, the privacy system 210 may encrypt the training data using multiple keys, allowing for group-specific access to the encrypted training data and machine learning model results. This approach may enable different user groups to access and decrypt only the portions of the training data they are authorized to view, enhancing data security and access control. The privacy system 210 may implement a key management mechanism that generates and distributes distinct sets of keys to authorized user groups.

Additionally, the privacy system 210 may segment the training data into multiple segments and may encrypt each segment using a different set of keys. This segmentation and encryption technique may ensure that even if multiple users access the machine learning model, they can only decrypt and view the segments they are authorized to access. This may provide a granular level of access control and may enhance the security of the training data and the resulting machine learning model.

The privacy system 210 may enable searching within the encrypted training data using encrypted keywords. This feature may allow the privacy system 210 to maintain the encryption of the training data while still being able to perform searches. For example, when a keyword is encrypted using the same format-preserving encryption technique, the encrypted keyword can be used to search through the encrypted training data. The privacy system 210 can match the encrypted keyword with encrypted tokens in the training data without decrypting the data. This capability may ensure that sensitive information remains protected during search operations and that only authorized users with the proper decryption key can access the decrypted search results.

As shown in FIG. 2C, and by reference number 230, the privacy system 210 may train the machine learning model with the encrypted training data to generate a trained machine learning model. For example, the privacy system 210 may train the machine learning model with the encrypted training data using various techniques to generate the trained machine learning model. In some implementations, the privacy system 210 may utilize homomorphic encryption to train the machine learning model with the encrypted training data. Homomorphic encryption may enable computations to be performed on encrypted training data without decrypting the encrypted training data. The privacy system 210 may prepare the encrypted training data for training by converting the encrypted training data into a suitable format, and may initialize the machine learning model with the encrypted training data. The privacy system 210 may train the machine learning model is trained using the homomorphic encryption, which allows computations to be performed on the encrypted training data. The privacy system 210 may then generate the trained machine learning model in an encrypted form.

In some implementations, the privacy system 210 may utilize one or more machine learning systems to train the machine learning model with the encrypted training data to generate the trained machine learning model. For example, the privacy system 210 may utilize linear regression (e.g., a supervised learning system), logistic regression (e.g., a supervised learning system) to train a machine learning model with encrypted data, decision trees (e.g., a type of machine learning system), or neural networks (e.g., a type of machine learning system) to train the machine learning model with encrypted training data to generate the trained machine learning model. In some implementations, the privacy system 210 may establish training parameters for training the machine learning model, such as a learning rate, a batch size, a number of epochs, and/or the like. The learning rate is a hyperparameter that controls how quickly the machine learning model learns from the encrypted training data. The batch size is a hyperparameter that controls a number of samples used to train the machine learning model at one time. The number of epochs is a hyperparameter that controls a number of times the machine learning model is trained on the encrypted training data. In some implementations, the privacy system 210 may store the trained machine learning model in a secure storage system to prevent unauthorized access, and may implement access control mechanisms to control who can access the trained machine learning model. In this way, the trained machine learning model may provide improved security, as it is difficult for an attacker to retrieve the original machine learning model without the decryption key; may preserve the privacy of the training data, as it is not possible to retrieve the original training data from the trained machine learning model; and complies with regulations that require the protection of sensitive data.

In addition to encrypting the training data, the privacy system 210 may ensure that the machine learning model is encrypted, including all tokens and intermediate computations. This encryption may prevent unauthorized access to both the training data and the trained machine learning model. During utilization, the privacy system 210 may process queries in encrypted form, ensuring that unauthorized users cannot access sensitive information even if they manage to intercept the trained machine learning model or query. By encrypting tokens and maintaining encrypted search mechanisms, the privacy system 210 protects against unauthorized extraction of information from the model at multiple levels.

As shown in FIG. 2D, and by reference number 235, the privacy system 210 may receive a query from the user device 205 associated with the user. For example, the user may utilize the user device 205 to input the query, and may cause the user device 205 to provide the query to the privacy system 210. In some implementations, the privacy system 210 may receive the query from the user device 205 through various interfaces and communication protocols. For example, the privacy system 210 may provide an API that allows the user device 205 to send the query to the privacy system 210. The API may be based on a representational state of resource (REST) protocol or other protocols. Alternatively, or additionally, the privacy system 210 may provide a web interface that allows the user device 205 to send the query to the privacy system 210 through a web browser. Alternatively, or additionally, the privacy system 210 may provide a mobile application interface that allows the user device 205 to send the query to the privacy system 210 through a mobile application.

In some implementations, the user device 205 may provide the query to the privacy system 210 using the hypertext transfer protocol (HTTP), the hypertext transfer protocol secure (HTTPS) protocol, a WebSocket protocol (e.g., which allows for bidirectional communication), a message queue protocol, and/or the like. In some implementations, the user device 205 may send a text query to the privacy system 210, which may be in the form of a string or a JavaScript object notation (JSON) object. Alternatively, or additionally, the user device 205 may send a structured query to the privacy system 210, which may be in the form of an SQL query or a GraphQL query. Alternatively, or additionally, the user device 205 may send a voice query to the privacy system 210, which may be in the form of an audio file or a text transcript. In some implementations, the privacy system 210 may process the query to determine an intent of the user and a type of data required to respond to the query. Alternatively, or additionally, the privacy system 210 may validate the query to ensure that the query is valid and not malicious. Alternatively, or additionally, the privacy system 210 may store the query for auditing and logging purposes.

As further shown in FIG. 2D, and by reference number 240, the privacy system 210 may encrypt the query to generate an encrypted query. For example, the privacy system 210 may utilize a format-preserving encryption technique to encrypt the query and generate the encrypted query. In some implementations, the format-preserving encryption technique may include format-preserving Feistel-based encryption. The format-preserving encryption technique may preserve a format of the query so that the encrypted query has the same format as the query (e.g., encrypting a string of characters to a string of characters).

In some implementations, the privacy system 210 may encrypt the query using other encryption techniques to generate the encrypted query. For example, the privacy system 210 may utilize a symmetric key encryption algorithm, such as advanced encryption standard, to encrypt the query. In this approach, a same key may be utilized for both encryption and decryption. Alternatively, or additionally, the privacy system 210 may utilize an asymmetric key encryption algorithm, such as Rivest-Shamir-Adleman, to encrypt the query. In this approach, a pair of keys may be utilized (e.g., a public key for encryption and a private key for decryption). Alternatively, or additionally, the privacy system 210 may utilize homomorphic encryption to encrypt the query, which allows computations to be performed on the encrypted query without decrypting the query. In this approach, the encrypted query may be processed using a homomorphic encryption algorithm, such as Brakerski-Gentry-Vaikuntanathan or Fan-Vercauteren. Alternatively, or additionally, the privacy system 210 may utilize tokenization to encrypt the query. In this approach, sensitive data in the query (e.g., credit card numbers, social security numbers, PII, and/or the like) may be replaced with a token that can be used for processing without exposing the sensitive data.

The encryption process may include the privacy system 210 generating a key or a pair of keys for encryption and decryption, and preparing the query for encryption by converting the query into a suitable format. The privacy system 210 may encrypt the query using the selected encryption algorithm and key to generate the encrypted query, and may store the encrypted query in a secure storage system. The privacy system 210 may utilize various encryption keys to encrypt the query, including a symmetric key (e.g., a single key that is used for both encryption and decryption), a public key (e.g., a key that is used for encryption, while a corresponding private key is used for decryption), and private key (e.g., a key that is used for decryption, while the corresponding public key is used for encryption).

In some implementations, the privacy system 210 may utilize space tokenization to scramble the characters within the query using one or more private keys. This technique may include dividing the text into tokens (e.g., words or characters), and then encrypting each token individually while preserving the overall format and structure of the text. Space tokenization may ensure that the encrypted query maintains the same layout and length characteristics as the original query.

As shown in FIG. 2E, and by reference number 245, the privacy system 210 may process the encrypted query, with the trained machine learning model, to generate an encrypted result. For example, the privacy system 210 may process the encrypted query with the trained machine learning model using various techniques to generate the encrypted result. In some implementations, the privacy system 210 may utilize homomorphic encryption to process the encrypted query with the trained machine learning model. Homomorphic encryption may allow computations to be performed on the encrypted query without decrypting the encrypted query. For example, the privacy system 210 may utilize linear homomorphic encryption to process the encrypted query with the trained machine learning model. Linear homomorphic encryption may enable linear computations to be performed on the encrypted query. Alternatively, or additionally, the privacy system 210 may utilize non-linear homomorphic encryption to process the encrypted query with the trained machine learning model. Non-linear homomorphic encryption may enable non-linear computations to be performed on the encrypted query. Alternatively, or additionally, the privacy system 210 may utilize homomorphic neural networks to process the encrypted query with the trained machine learning model. Homomorphic neural networks enable computations to be performed on the encrypted query using neural networks.

In some implementations, the privacy system 210 may perform computations on the encrypted query and the trained machine learning model using homomorphic encryption, and may generate the encrypted result based on the computations performed on the encrypted query and the trained machine learning model. The privacy system 210 may further encrypt the encrypted result to ensure that the encrypted result is protected from unauthorized access. In this way, the privacy system 210 may provide improved security since as the query and the machine learning model are encrypted and protected from unauthorized access. The privacy system 210 may preserve the privacy of the user since the query and the machine learning model are processed and responded to in an encrypted manner. The privacy system 210 may comply with regulations that require the protection of sensitive data when processing the encrypted query, with the trained machine learning model.

As shown in FIG. 2F, and by reference number 250, the privacy system 210 may provide the encrypted result to the user device 205 associated with the user. For example, the privacy system 210 may provide the encrypted result to the user device 205 associated with the user through various interfaces and communication protocols. In some implementations, the privacy system 210 may provide an API that allows the user device 205 to receive the encrypted result from the privacy system 210. The API may be based on the REST protocol or other protocols. Alternatively, or additionally, the privacy system 210 may provide a web interface that allows the user device 205 to receive the encrypted result through a web browser. Alternatively, or additionally, the privacy system 210 may provide a mobile application interface that allows the user device 205 to receive the encrypted result through a mobile application. In some implementations, the privacy system 210 may utilize HTTP, the HTTPS protocol, the WebSocket protocol, or a message queue protocol to transmit the encrypted result to the user device 205. In some implementations, the privacy system 210 may package the encrypted result in a format suitable for transmission, such as a JSON object or a binary blob, and may further encrypt the packaged result to ensure protection from unauthorized access during transmission. In this way, the privacy system 210 may provide improved security since the result is encrypted and protected from unauthorized access during transmission, may preserve the privacy of the user since the result is processed and responded to in an encrypted manner, and may comply with regulations that require the protection of sensitive data.

As further shown in FIG. 2F, and by reference number 255, the user device 205 may utilize one or more private keys to decrypt the encrypted result and generate a result. For example, if the user and the user device 205 are authorized to review the result, the user device 205 may include one or more private keys required to decrypt the encrypted result. In some implementations, the user device 205 may store the one or more private keys in a secure storage location, such as a hardware security module or a trusted execution environment. The user device 205 may implement a key management system to manage the one or more private keys, including generating, storing, and revoking the one or more private keys. When the encrypted result is received from the privacy system 210, the user device 205 may retrieve the one or more private keys associated with the encrypted result from the secure storage location, and may utilize the one or more private keys to decrypt the encrypted result, utilizing a decryption algorithm such as AES or RSA. The user device 205 may generates the result from the decrypted data, which may involve processing the data in a specific way or rendering the data in a user-friendly format.

In some implementations, the user device 205 may utilize a symmetric key decryption algorithm (e.g., AES) to decrypt the encrypted result, may utilize an asymmetric key decryption algorithm (e.g., RSA) to decrypt the encrypted result, may utilize a hybrid decryption algorithm, which combines symmetric and asymmetric key decryption techniques, to decrypt the encrypted result, and/or the like. In some implementations, the user device 205 may generate a pair of keys, including a public key and a private key, using a key generation algorithm. The user device 205 may provide the public key to the privacy system 210, and may keep the private key secure. The user device 205 may revoke the private key when the private key is no longer needed or when the private key is compromised. In some implementations, the user device 205 may authenticate the privacy system 210 before decrypting the encrypted result to ensure that the result comes from a trusted source. The user device 205 may check the authorization of the user to access the encrypted result to ensure that only authorized users can decrypt the result. The user device 205 may encrypt the result again after decryption to ensure that the result is protected from unauthorized access.

As further shown in FIG. 2F, and by reference number 260, the user device 205 may provide the result for display to the user. For example, the user device 205 may provide the result for display to the user through various interfaces and rendering techniques. In some implementations, the user device 205 may use a graphical user interface (GUI) to display the result to the user. The GUI may include visual elements such as windows, icons, and menus to render the result in a user-friendly format. Alternatively, or additionally, the user device 205 may utilize a command line interface (CLI) to display the result to the user. The CLI may include text-based commands and output to render the result in a straightforward format. Alternatively, or additionally, the user device 205 may utilize a voice assistant interface to display the result to the user. The voice assistant may utilize natural language processing (NLP) to render the result in a spoken format.

In some implementations, the user device 205 may utilize text rendering techniques to display the result as text. The text may be rendered in various fonts, sizes, and colors to enhance readability. Alternatively, or additionally, the user device 205 may utilize image rendering techniques to display the result as an image. Alternatively, or additionally, the user device 205 may utilize graph rendering techniques to display the result as a graph. The graph may be rendered in various formats, such as a bar chart, pie chart, or line chart. Alternatively, or additionally, the user device 205 may utilize video rendering techniques to display the result as a video. In some implementations, the user device 205 may adjust display parameters when providing the result to the user. For example, the user device 205 may adjust a resolution of a display to ensure that the result is rendered clearly and accurately, may adjust a color depth of the display to ensure that the result is rendered with sufficient color accuracy, may adjust a brightness of the display to ensure that the result is rendered at a comfortable level for the user, and/or the like. In some implementations, the user device 205 may require authentication before displaying the result to ensure that only authorized users can access the result. The user device 205 may check the authorization of the user to access the result to ensure that only authorized users can view the result.

As shown in FIG. 2G, and by reference number 265, the user device 205 may fail to decrypt the encrypted result and generate the result. For example, if the user and the user device 205 are not authorized to review the result, the user device 205 may not include the one or more private keys required to decrypt the encrypted result. In some implementations, when the user device 205 does not include the one or more private keys required to decrypt the result, the user device 205 may fail to decrypt the encrypted result and may fail to generate the result. In some implementations, the user device 205 may fail to decrypt the encrypted result for other reason. For example, the user device 205 may include an invalid private key (e.g., lost, expired, or revoked) that fails to decrypt the encrypted result. Alternatively, or additionally, the user device 205 may utilize an incorrect decryption algorithm that fails to decrypt the encrypted result. Alternatively, or additionally, the encrypted result may be corrupted during transmission or storage, making it impossible for the user device 205 to decrypt.

As further shown in FIG. 2G, and by reference number 270, the user device 205 may provide an error message for display to the user. For example, when the user device 205 fails to decrypt the encrypted result and fails to generate the result, the user device 205 may generate an error message indicating that the decryption process has failed. The user device 205 may display the error message to the user so that the user may take corrective action. In some implementations, the user device 205 may have a retry mechanism that allows the user to retry the decryption process when the user device 205 fails to decrypt the encrypted result. Alternatively, or additionally, the user device 205 may offer alternative decryption methods, such as using a different private key or decryption algorithm, when the user device 205 fails to decrypt the encrypted result.

In some implementations, the privacy system 210 is designed to handle various types of sensitive information, making the privacy system 210 suitable for a wide range of applications. Use cases may include encrypting and securely processing medical records to protect patient privacy, handling classified documents to ensure compliance with security protocols, and managing PII to prevent unauthorized access and data breaches. By encrypting data at rest, in transit, and during processing, the privacy system 210 may provide robust protection for sensitive information in diverse scenarios.

The privacy system 210 may be compatible with various types of machine learning models, including large language models (LLMs). The privacy system 210 may support the encryption of training data and models for LLMs, ensuring that sensitive information is protected during training and utilization. Furthermore, the privacy system 210 may address challenges associated with quantization, which reduces a model size for deployment on devices such as smartphones. By encrypting the model and its tokens, the privacy system 210 may prevent unauthorized access to sensitive information even if the quantized model is downloaded onto a device. The encryption ensures that only authorized users with the proper decryption key can interact with the model and extract meaningful information.

The privacy system 210 is versatile and can be applied to various types of data beyond text. For example, the privacy system 210 may support the encryption of byte streams and features derived from non-text data, such as images and sound samples. This capability may ensure that sensitive information embedded in multimedia data remains protected. For example, features extracted from images or sound samples can be encrypted using format-preserving encryption techniques, allowing the privacy system 210 to securely train machine learning models and process queries related to multimedia data. The encryption may preserve high variance in elements used for training, and may maintain the effectiveness of the model while ensuring data privacy.

In this way, the privacy system 210 provides encrypted machine learning model training and result generation. For example, the privacy system 210 may reduce the computational overhead associated with protecting sensitive data by avoiding the need to implement additional data anonymization or pseudonymization techniques. The privacy system 210 may minimize the risk of data breaches and associated resource-intensive incident response efforts. Additionally, the privacy system 210 may enable efficient encryption and decryption of data without requiring significant additional computational resources or bandwidth. Furthermore, the privacy system 210 may reduce storage requirements by enabling secure data storage without requiring redundant or duplicate storage of sensitive data. Thus, the privacy system 210 conserves computing resources, networking resources, and/or the like that would otherwise have been consumed by attempting to decrypt training data prior to training machine learning models, handling exposure of sensitive information to unauthorized parties during training of machine learning models, handling exposure of sensitive information to unauthorized parties during utilization of machine learning models, and/or the like.

As indicated above, FIGS. 2A-2G are provided as an example. Other examples may differ from what is described with regard to FIGS. 2A-2G. The number and arrangement of devices shown in FIGS. 2A-2G are provided as an example. In practice, there may be additional devices, fewer devices, different devices, or differently arranged devices than those shown in FIGS. 2A-2G. Furthermore, two or more devices shown in FIGS. 2A-2G may be implemented within a single device, or a single device shown in FIGS. 2A-2G may be implemented as multiple, distributed devices. Additionally, or alternatively, a set of devices (e.g., one or more devices) shown in FIGS. 2A-2G may perform one or more functions described as being performed by another set of devices shown in FIGS. 2A-2G.

FIG. 3 is a flowchart of an example process 300 associated with providing encrypted machine learning model training and result generation. One or more process blocks of FIG. 3 are performed by a computer system (e.g., computer 102 and/or the privacy system 210) and/or by another device or a group of devices separate from or including the computer system. Additionally, or alternatively, one or more process blocks of FIG. 3 may be performed by one or more components of computer 102, such as processor set 114, communication fabric 116, volatile memory 118, and/or privacy code 150.

As shown in FIG. 3, process 300 may include receiving training data (block 310). For example, the computer system may receive training data, as described above.

As further shown in FIG. 3, process 300 may include encrypting the training data to generate encrypted training data (block 320). For example, the computer system may encrypt the training data to generate encrypted training data, as described above. In some implementations, encrypting the training data to generate the encrypted training data includes encrypting the training data using a format-preserving encryption technique to generate the encrypted training data. In some implementations, the format-preserving encryption technique is format-preserving Feistel-based encryption. In some implementations, encrypting the training data to generate the encrypted training data includes encrypting the training data using multiple keys to generate the encrypted training data. In some implementations, encrypting the training data to generate the encrypted training data includes utilizing tokenization to scramble characters in the training data and generate the encrypted training data.

As further shown in FIG. 3, process 300 may include training a machine learning model with the encrypted training data to generate a trained machine learning model (block 330). For example, the computer system may train a machine learning model with the encrypted training data to generate a trained machine learning model, as described above. In some implementations, the machine learning model is a bag-of-words model.

As further shown in FIG. 3, process 300 may include receiving a query from a user device associated with a user (block 340). For example, the computer system may receive a query from a user device associated with a user, as described above.

As further shown in FIG. 3, process 300 may include encrypting the query to generate an encrypted query (block 350). For example, the computer system may encrypt the query to generate an encrypted query, as described above. In some implementations, encrypting the query to generate the encrypted query includes encrypting the query using a format-preserving encryption technique to generate the encrypted query.

As further shown in FIG. 3, process 300 may include processing the encrypted query, with the trained machine learning model, to generate an encrypted result (block 360). For example, the computer system may process the encrypted query, with the trained machine learning model, to generate an encrypted result, as described above. In some implementations, processing the encrypted query, with the trained machine learning model, to generate the encrypted result includes searching the encrypted training data to identify information responsive to the encrypted query, without decrypting the encrypted training data.

As further shown in FIG. 3, process 300 may include providing the encrypted result to the user device (block 370). For example, the computer system may provide the encrypted result to the user device, as described above. In some implementations, the encrypted result causes the user device to utilize one or more private keys to decrypt the encrypted result and generate a result and to provide the result for display to the user. In some implementations, the encrypted result causes the user device to fail to decrypt the encrypted result and to provide an error message for display to the user.

In some implementations, process 300 includes segmenting the training data to generate a plurality of training data segments, and encrypting each of the plurality of training data segments with a different set of keys. In some implementations, process 300 includes preserving a format of text in the training data when encrypting the training data to generate the encrypted training data. In some implementations, process 300 includes preserving a format of text in the query when encrypting the query to generate the encrypted query.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various implementations of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving training data;
encrypting the training data to generate encrypted training data;
training a machine learning model with the encrypted training data to generate a trained machine learning model;
receiving a query from a user device associated with a user;
encrypting the query to generate an encrypted query;
processing the encrypted query, with the trained machine learning model, to generate an encrypted result; and
providing the encrypted result to the user device.

2. The method of claim 1, wherein encrypting the training data to generate the encrypted training data comprises:
encrypting the training data using a format-preserving encryption technique to generate the encrypted training data.

3. The method of claim 2, wherein the format-preserving encryption technique is format-preserving Feistel-based encryption.

4. The method of claim 1, wherein encrypting the query to generate the encrypted query comprises:
encrypting the query using a format-preserving encryption technique to generate the encrypted query.

5. The method of claim 1, wherein the machine learning model is a bag-of-words model.

6. The method of claim 1, wherein the encrypted result causes the user device to utilize one or more private keys to decrypt the encrypted result, generate a result, and provide the result for display to the user.

7. The method of claim 1, wherein encrypting the training data to generate the encrypted training data comprises:
encrypting the training data using multiple keys to generate the encrypted training data.

8. A computer system, comprising:
a processor set;
one or more computer-readable storage media; and
program instructions stored on the one or more computer-readable storage media to cause the processor set to perform operations comprising:
receiving training data;
encrypting the training data to generate encrypted training data;
training a machine learning model with the encrypted training data to generate a trained machine learning model;
receiving a query from a user device associated with a user;
encrypting the query to generate an encrypted query;
processing the encrypted query, with the trained machine learning model, to generate an encrypted result; and
providing the encrypted result to the user device,
wherein the encrypted result causes the user device to utilize one or more private keys to decrypt the encrypted result, generate a result, and provide the result for display to the user.

9. The computer system of claim 8, wherein encrypting the training data to generate the encrypted training data comprises:
encrypting the training data using multiple keys to generate the encrypted training data.

10. The computer system of claim 8, wherein the operations further comprise:
segmenting the training data to generate a plurality of training data segments; and
encrypting each of the plurality of training data segments with a different set of keys.

11. The computer system of claim 8, wherein encrypting the training data to generate the encrypted training data comprises:
utilizing tokenization to scramble characters in the training data and generate the encrypted training data.

12. The computer system of claim 8, wherein the operations further comprise:
preserving a format of text in the training data when encrypting the training data to generate the encrypted training data.

13. The computer system of claim 8, wherein the operations further comprise:
preserving a format of text in the query when encrypting the query to generate the encrypted query.

14. The computer system of claim 8, wherein processing the encrypted query, with the trained machine learning model, to generate the encrypted result comprises:
searching the encrypted training data to identify information responsive to the encrypted query, without decrypting the encrypted training data.

15. A computer program product, comprising:
one or more computer-readable storage media; and
program instructions stored on the one or more computer-readable storage media to perform operations comprising:
receiving training data;
encrypting the training data using a format-preserving encryption technique to generate encrypted training data;
training a machine learning model with the encrypted training data to generate a trained machine learning model;
receiving a query from a user device associated with a user;
encrypting the query using the format-preserving encryption technique to generate an encrypted query;
processing the encrypted query, with the trained machine learning model, to generate an encrypted result; and
providing the encrypted result to the user device.

16. The computer program product of claim 15, wherein the format-preserving encryption technique is format-preserving Feistel-based encryption.

17. The computer program product of claim 15, wherein the operations further comprise:
preserving a format of text in the training data when encrypting the training data using the format-preserving encryption technique to generate the encrypted training data.

18. The computer program product of claim 15, wherein the operations further comprise:
preserving a format of text in the query when encrypting the query using the format-preserving encryption technique to generate the encrypted query.

19. The computer program product of claim 15, wherein processing the encrypted query, with the trained machine learning model, to generate the encrypted result comprises:
searching the encrypted training data to identify information responsive to the encrypted query, without decrypting the encrypted training data.

20. The computer program product of claim 15, wherein the encrypted result causes the user device to utilize one or more private keys to decrypt the encrypted result and generate a result and to provide the result for display to the user.
